(19) United States
(12) Patent Application Publication
(10) Pub. No.: US 2024/0154365 A1
(43) Pub. Date: May 9, 2024

(54) ELECTRICAL CONNECTOR CONTACT ASSEMBLY HAVING UPPER AND LOWER CAPS WITH INTEGRATED GROUND BARS

(71) Applicants: Foxconn (Kunshan) Computer Connecor., Ltd., Kunshan (CN); Foxconn Interconnect Technology Limited., Grand Cayman (KY)

(72) Inventor: TERRANCE F. LITTLE, Fullerton, CA (US)

(21) Appl. No.: 18/503,346

(22) Filed: Nov. 7, 2023

Related U.S. Application Data
(60) Provisional application No. 63/382,775, filed on Nov. 8, 2022.

(51) Int. Cl. H01R 13/6471

(52) U.S. Cl. CPC H01R 13/6471

(57) ABSTRACT

A contact assembly for an electrical connector includes: a lower contact module having an insulator and plural signal and ground contacts carried by the insulator; a lower cap with an integrated lower ground bar in contact with the ground contacts of the lower contact module; an upper contact module having an insulator and plural signal and ground contacts carried by the insulator; a pair of side plates attached to the insulator of the lower contact module, the lower cap, and the insulator of the upper contact module; and an upper cap with an upper ground bar in contact with the ground contacts of the upper contact module, wherein each of the lower ground bar and the upper ground bar has a pair of end portions in contact with the pair of side plates.

### CROSS REFERENCE TO RELATED APPLICATION

This application claims priority to and benefit of U.S. Provisional Patent Application No. 63/382,775, filed Nov. 8, 2022.

### BACKGROUND OF THE INVENTION

### Field of the Invention

The present invention relates to a contact assembly for an electrical connector, comprising an upper and lower contact modules and a pair of side plates attached to the upper and lower contact modules, and an upper and lower ground bars in contact with respective ground contacts of the upper and lower contact modules.

### Description of Related Arts

U.S. Patent Application Publication No. 2021/0336360 discloses an electrical connector including, among others, a top port wafer assembly and a pair of supporting side plates each configured with one or more apertures to receive one or more protrusions of each wafer of the top port wafer assembly, and one or more separate, conductive ground shield elements configured to cover one or more differential high-speed terminals of a wafer (generating a field affinity between respective ground shield and the differential high-speed terminals or not). Also disclosed are methods and structures that combine metal ground conductors/terminals and plastic conductive ground shields, e.g., by stitchably mating one or more insert molded metal ground conductors with a respective ground conductive section that is part of a ground shield element.

U.S. Pat. No. 11,189,943 discloses an electrical connector including, among others, a plurality of terminal subassemblies and a pair of ground clips configured to electrically couple each of the terminal subassemblies together and to ground each of the terminal subassemblies to a printed circuit board

### SUMMARY OF THE INVENTION

A contact assembly for an electrical connector comprises: a lower contact module having an insulator and plural signal and ground contacts carried by the insulator; a lower cap with an integrated lower ground bar in contact with the ground contacts of the lower contact module; an upper contact module having an insulator and plural signal and ground contacts carried by the insulator; a pair of side plates attached to the insulator of the lower contact module, the lower cap, and the insulator of the upper contact module; and an upper cap with an upper ground bar in contact with the ground contacts of the upper contact module, wherein each of the lower ground bar and the upper ground bar has a pair of end portions in contact with the pair of side plates. Instead of being in contact with the ground contacts, an upper ground bar of a varied design is in close proximity to the signal contacts of the upper contact module.

### BRIEF DESCRIPTION OF DRAWINGS

FIG. 1 is a perspective view of an electrical connector incorporating a contact assembly in accordance with the present invention;

FIG. 2 is a view similar to FIG. 1 but from another perspective;

FIG. 3 is an exploded view of the electrical connector from still another perspective;

FIG. 4 shows another perspective view of an upper cap with an integrated upper ground bar of the contact assembly;

FIG. 5 is an exploded view of the upper cap and the upper ground bar in FIG. 4;

FIG. 6 is an exploded view of the electrical connector in FIG. 1;

FIG. 7 is a view similar to FIG. 6 but from another perspective;

FIG. 8 is an exploded view of the contact assembly omitting the upper cap and the upper ground bar;

FIG. 9 is a view similar to FIG. 8 but from another perspective;

FIG. 10 is a further exploded view of FIG. 8;

FIG. 11 is a perspective view showing selected components of the contact assembly;

FIG. 12 is a view similar to FIG. 11 but from another perspective;

FIG. 13 is a cross-sectional view of the electrical connector taken along line 13-13 in FIG. 1;

FIG. 14 shows both a perspective view and a front view of the upper ground bar;

FIG. 15 shows a pair of side plates of the contact assembly are attached to two outermost ground contacts of an upper contact module of the contact assembly;

FIG. 16 shows a perspective view of a varied upper ground bar;

FIG. 17 shows a varied upper cap with a varied upper ground bar;

FIG. 18 is a view similar to FIG. 17 but showing a tape of the upper ground bar applied in place to a flat copper of the upper ground bar;

FIG. 19 shows positional relationship between the varied upper ground bar and contacts of the upper contact module;

FIG. 20 shows another varied upper cap with another varied upper ground bar; and

FIG. 21 is a perspective view of an electrical connector omitting the another varied upper cap to show the another varied upper ground bar in FIG. 20.

### DETAILED DESCRIPTION OF THE DRAWINGS

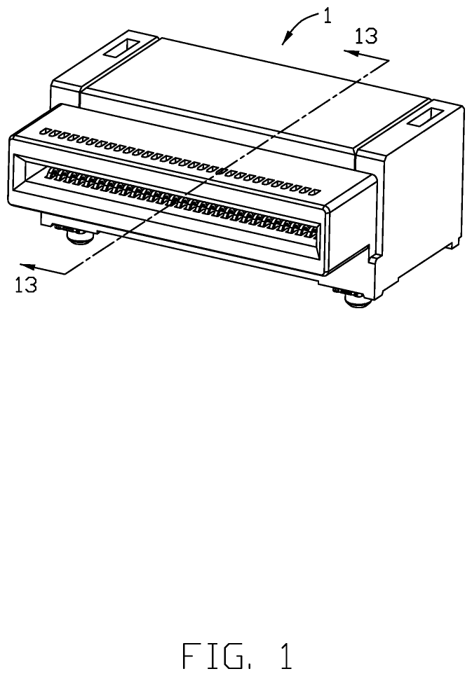

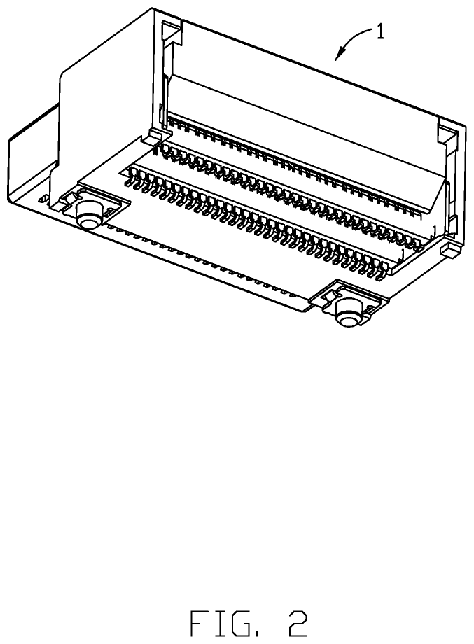

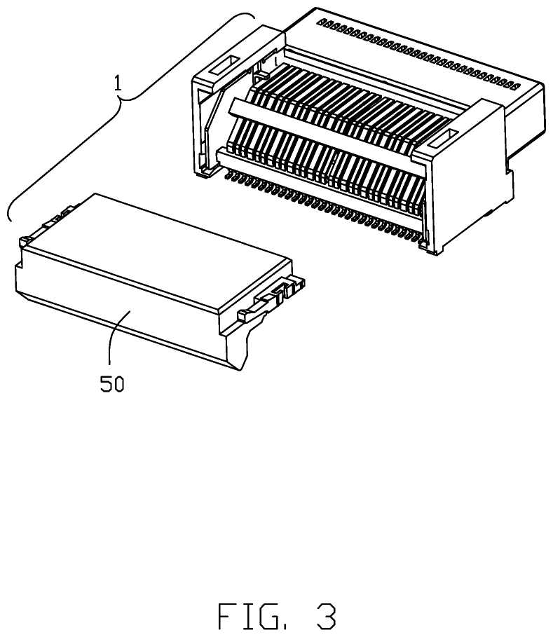

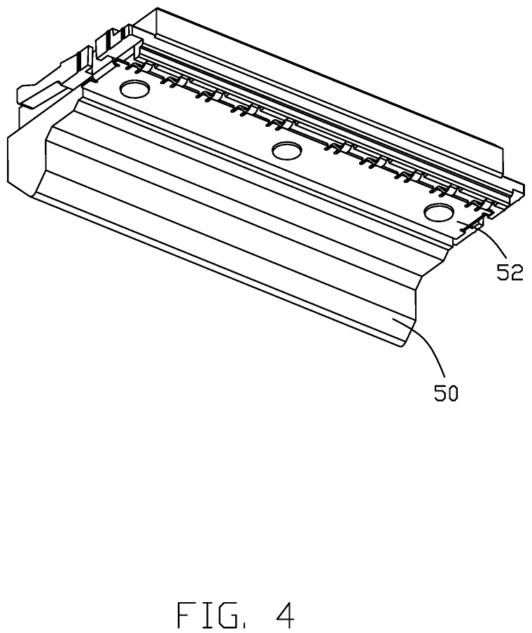

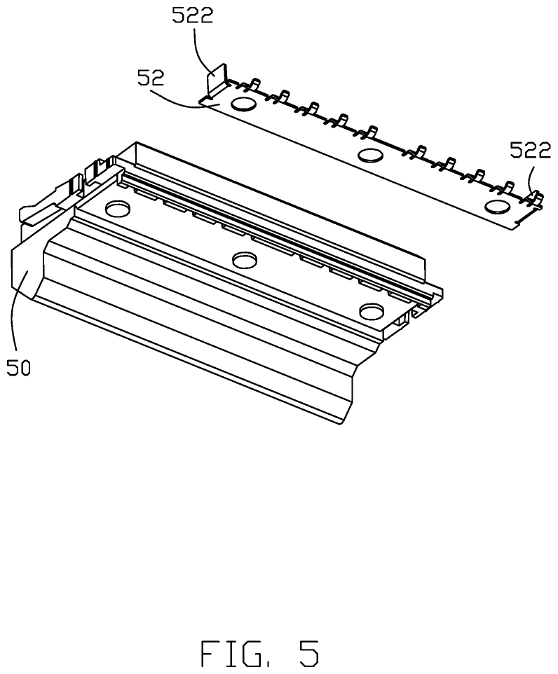

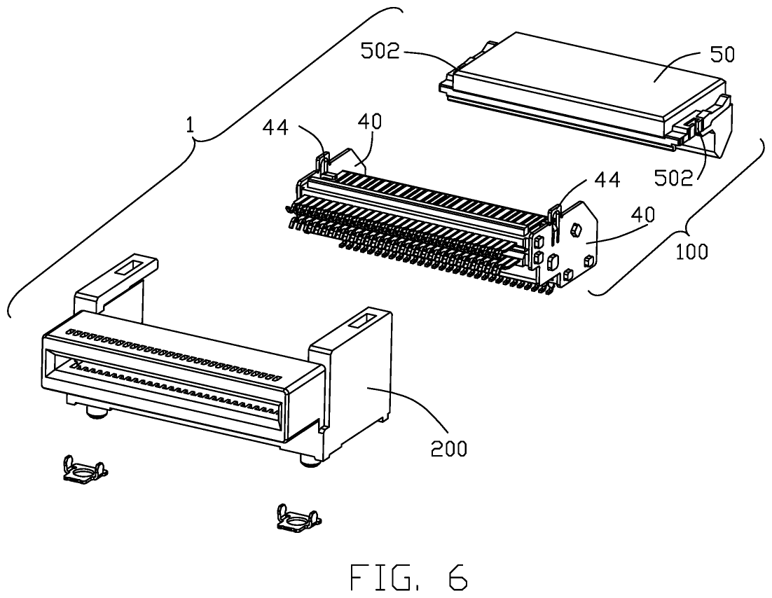

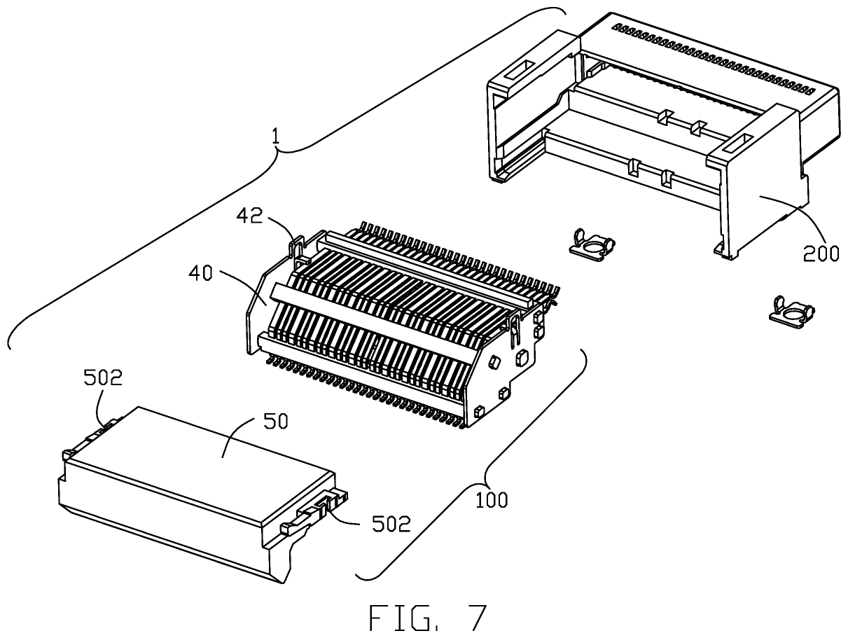

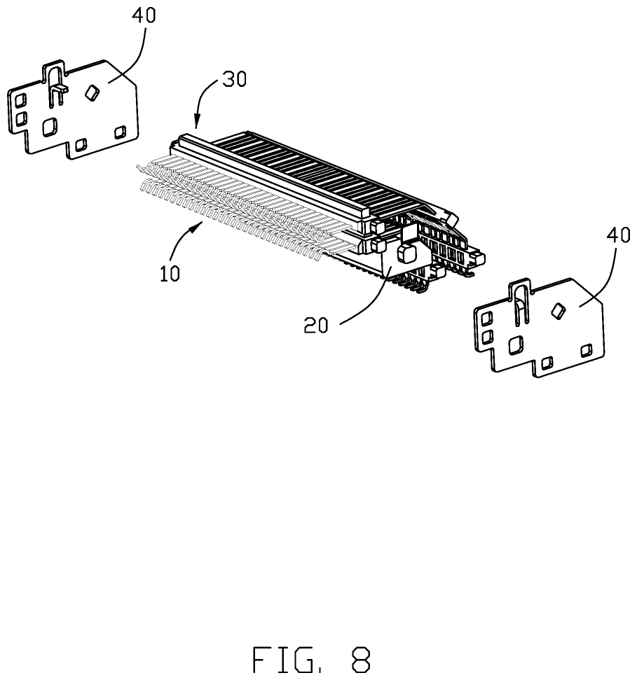

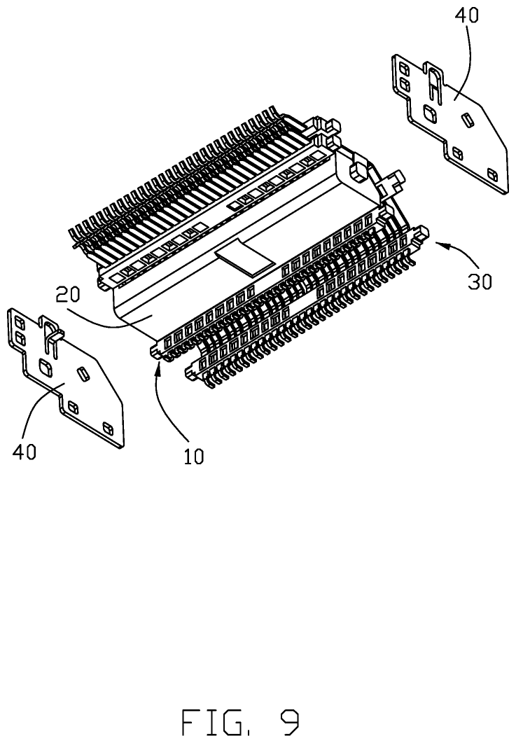

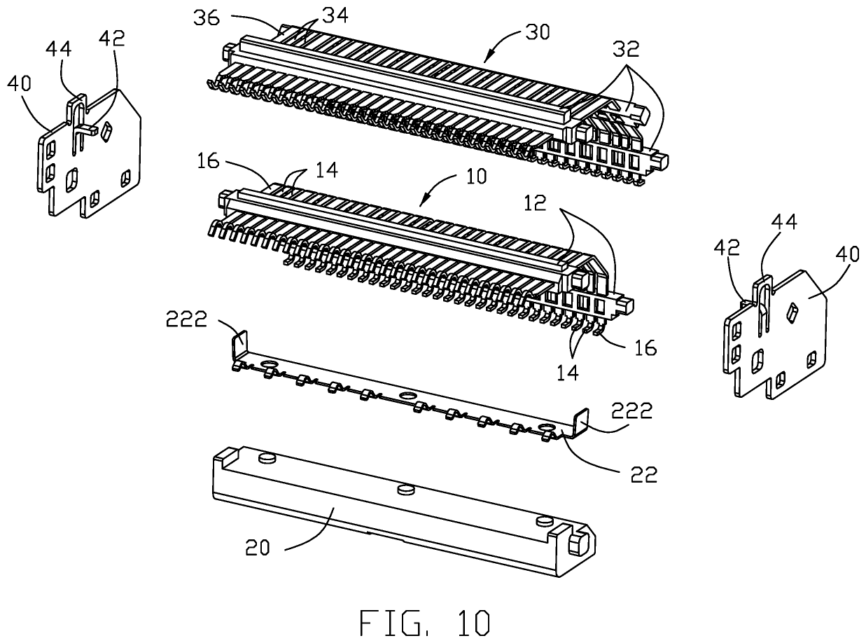

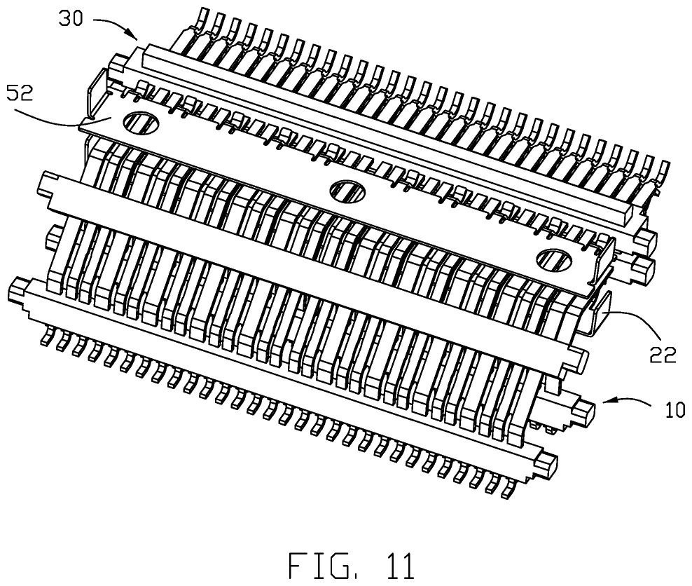

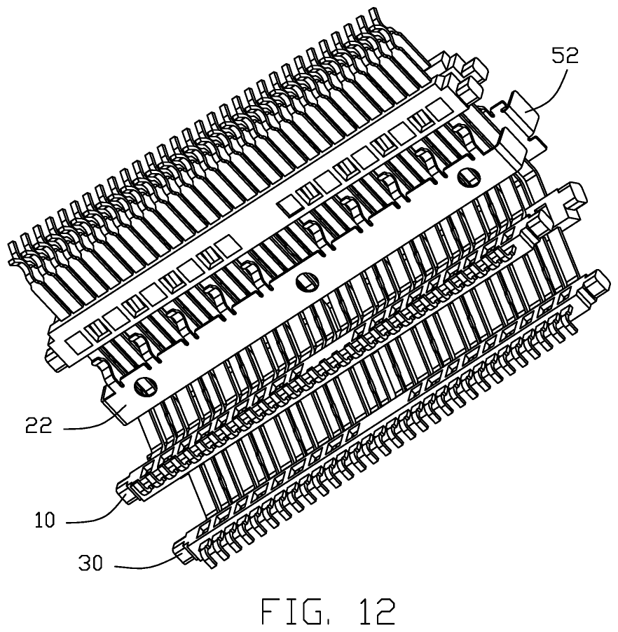

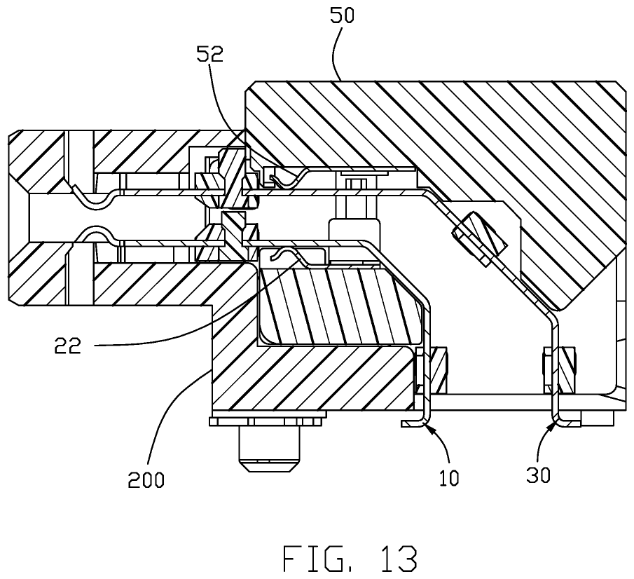

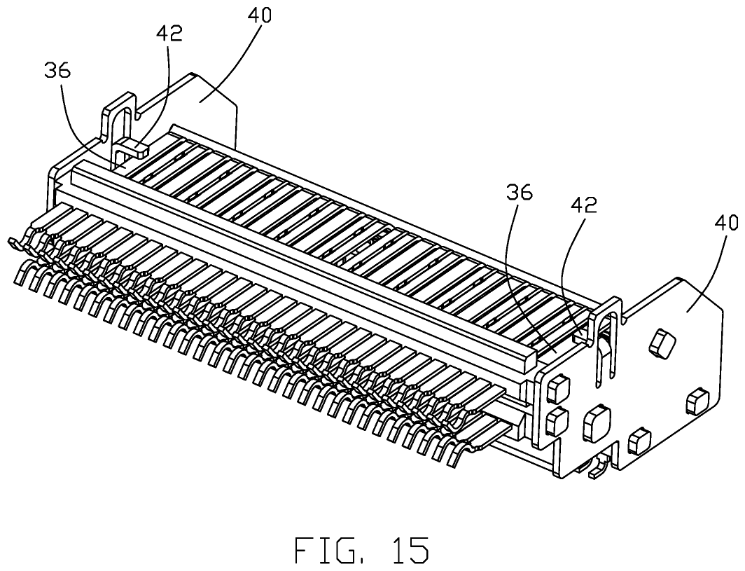

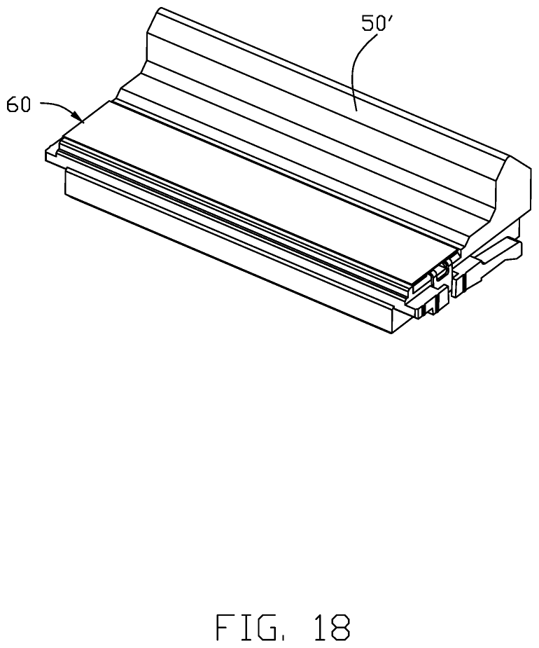

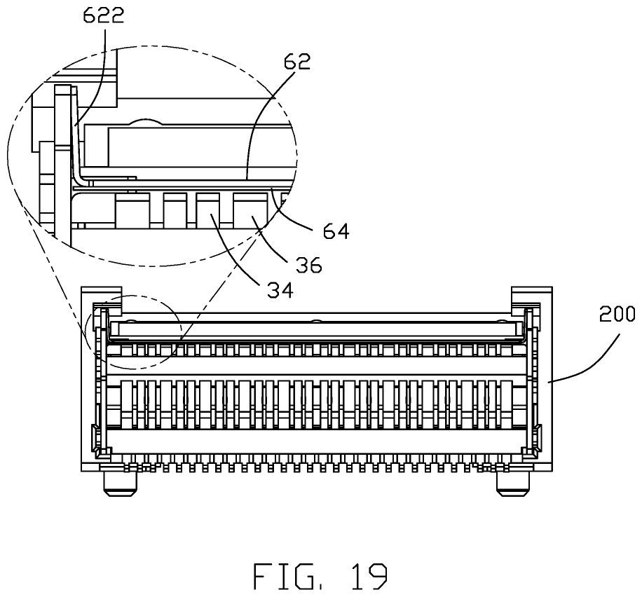

Referring to FIGS. 1-21, a contact assembly 100 for an electrical connector 1 comprises, as more clearly seen in FIGS. 5 and 10, a lower contact module 10 having an insulator 12 and a plurality of signal contacts 14 and ground contacts 16 carried by the insulator 12; a lower cap 20 with an integrated lower ground bar 22 in contact with the ground contacts 16 of the lower contact module 10; an upper contact module 30 having an insulator 32 and a plurality of signal contacts 34 and ground contacts 36 carried by the insulator 32; a pair of metallic side plates 40 attached to the insulator 12 of the lower contact module 10, the lower cap 20, and the insulator 32 of the upper contact module 30; and an upper cap 50 with an integrated upper ground bar 52 in contact with the ground contacts 36 of the upper contact module 30. The electrical connector 1 comprises an insulative housing 200 receiving the contact assembly 100. The lower ground bar 22 has a pair of end portions 222 and the upper ground bar 52 has a pair of end portions 522, both pairs of end portions 222 and 522 being in contact with the pair of side plates 40.

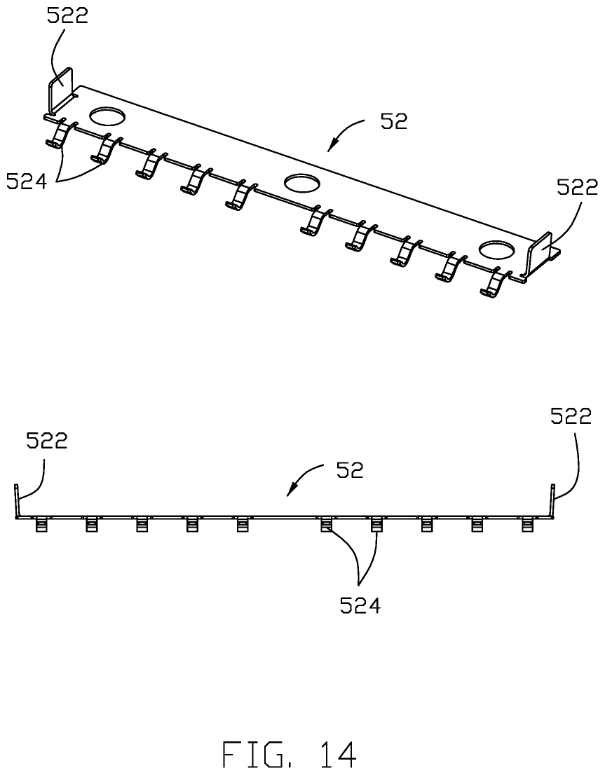

Each of the pair of side plates 40 has a finger 42 attached, e.g., by soldering or laser welding, to a corresponding one of two outermost ground contacts 36 of the upper contact module 30 after the upper contact module 30 and the lower contact module 10 are assembled and the pair of metallic side plates 40 are attached, e.g., by protrusions extending through apertures and heat staked. The pair of end portions 222 or 522 of each of the lower ground bar 22 and the upper ground bar 52 may be constructed as a respective pair of walls for bearing against the pair of side plates 40. To male compressive contact, the pair of walls may be slightly tilted outward, as seen in FIG. 14. The pair of walls are angled outward for approxately 3 degrees per side. The upper ground bar 50 and the lower ground bar 22 is stamped and formed from sheet metal.

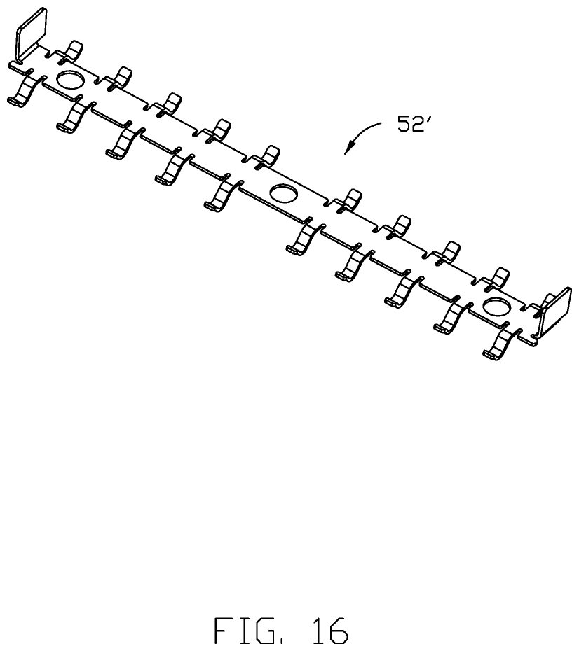

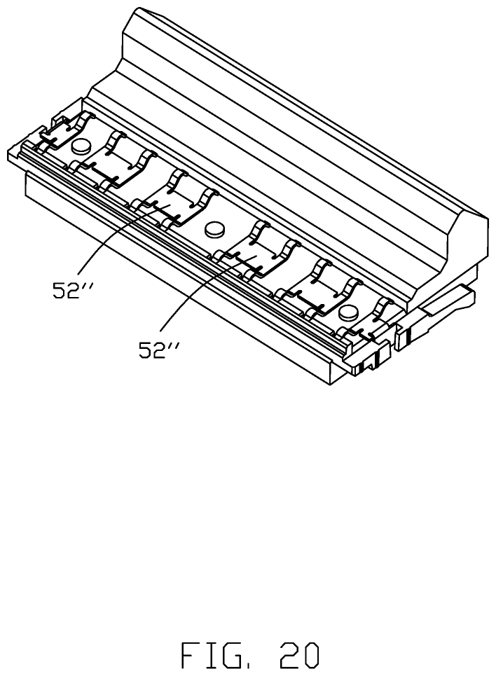

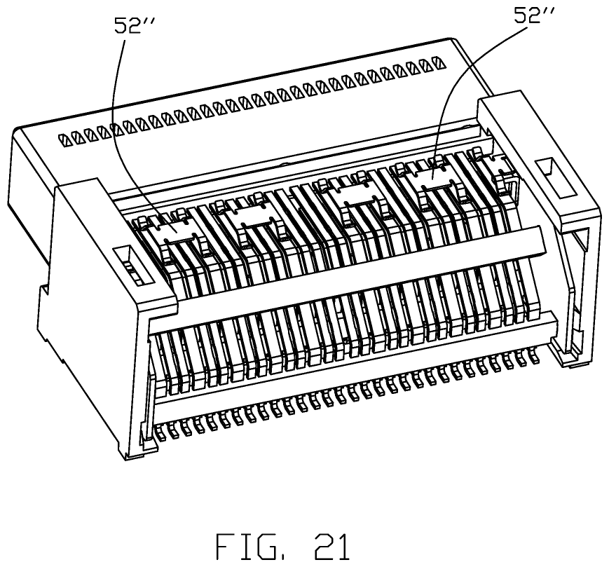

To be in contact with corresponding ground contacts 16 or 36, each of the lower ground bar 22 and the upper ground bar 52 has plural beams 54 in a row, as seen in FIG. 14. The upper ground bar 50 is assembled into the upper cap 50 and standoffs of the upper cap 50 are heat staked to keep it securely in place and, similarly, the lower ground bar 22 is assembled into the lower cap 20 and standoffs of the lower cap 20 are heat staked to keep it securely in place. An upper ground bar 52′ in a varied design may have two rows of beams and each of the ground contacts 36 of the upper contact module 30 may therefore be in contact with two corresponding beams, as seen in FIG. 16. An upper ground bar 52″ in another varied design may be suitably constructed as separated pieces as seen in FIGS. 20 and 21 in order to reduce the coupling effect between signal pairs and lower the crosstalk.

Each of the pair of side plates 40 may have an upper protrusion 44 and the upper cap 50 may have a pair of slots 502 each receiving a corresponding upper protrusion 44. The pair of slots 502 may also receive the pair of end portions 522 of the upper ground bar 52.

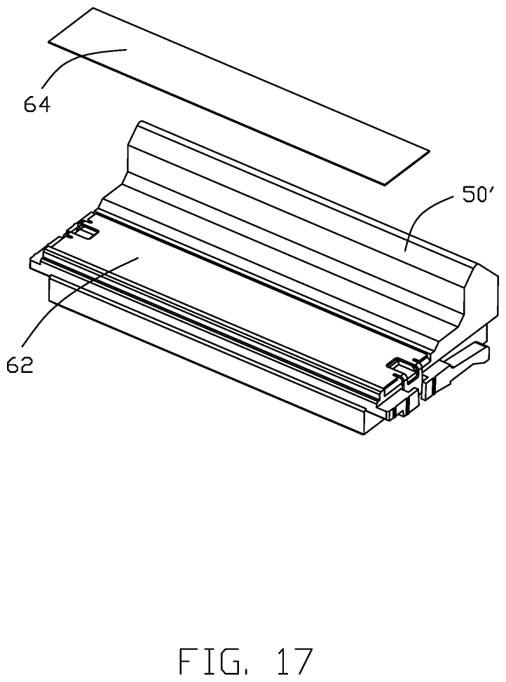

In another varied design, as shown in FIGS. 17-19, an upper ground bar 60 may be in close proximity to the signal contacts 34 of the upper contact module 30 to lower impedance while not having beams or like structure to contact the ground contacts 36. The upper ground bar 60 may include a flat copper 62 assembled to a corresponding upper cap 50′ and a tape applied on top of the flat copper 62. The flat copper 62 may be made by stamping and forming to have a pair of slightly outward tilted end walls 622. The pair of end walls 622 are angled outward for approximately 3 degrees per side. After the integrated copper ground bar with tape is assembled, the angled end walls 622 compress onto the side plates 40.

1. A contact assembly for an electrical connector, comprising:
a lower contact module having an insulator and a plurality of signal and ground contacts carried by the insulator;
a lower cap with an integrated lower ground bar in contact with the ground contacts of the lower contact module;
an upper contact module having an insulator and a plurality of signal and ground contacts carried by the insulator;
a pair of side plates attached to the insulator of the lower contact module, the lower cap, and the insulator of the upper contact module; and
an upper cap with an upper ground bar in contact with the ground contacts of the upper contact module; wherein
each of the lower ground bar and the upper ground bar has a pair of end portions in contact with the pair of side plates.

2. The contact assembly as claimed in claim 1, wherein each of the pair of side plates has a finger attached to a corresponding one of two outermost ground contacts of the upper contact module.

3. The contact assembly as claimed in claim 1, wherein the upper ground bar is constructed as separated pieces.

4. The contact assembly as claimed in claim 1, wherein the upper ground bar is constructed as integrated.

5. The contact assembly as claimed in claim 1, wherein the pair of side plates are attached to the upper contact module and the lower contact module by protrusions extending through apertures of the side plates and heat staked.

6. The contact assembly as claimed in claim 1, wherein the upper ground bar has two rows of beams, and each of the ground contacts of the upper contact module is in contact with two corresponding beams.

7. The contact assembly as claimed in claim 1, wherein the upper ground bar is assembled into the upper cap and standoffs of the upper cap are heat staked to keep it securely in place.

8. The contact assembly as claimed in claim 1, wherein the lower ground bar is assembled into the lower cap and standoffs of the lower cap are heat staked to keep it securely in place.

9. The contact assembly as claimed in claim 1, wherein the pair of end portions of each of the lower ground bar and the upper ground bar comprise a respective pair of walls bearing against the pair of side plates.

10. The contact assembly as claimed in claim 9, wherein the pair of walls of each of the lower ground bar and the upper ground bar are tilted outward to make compressive contact with the pair of side plates.

11. The contact assembly as claimed in claim 10, wherein each wall of the pair of walls is angled outward for approximately 3 degrees per side.

12. The contact assembly as claimed in claim 1, wherein each of the pair of side plates has an upper protrusion, and the upper cap has a pair of slots each receiving a corresponding upper protrusion.

13. The contact assembly as claimed in claim 1, wherein the upper cap has a pair of slots receiving the pair of end portions of the upper ground bar.

14. The contact assembly as claimed in claim 1, wherein each of the upper ground bar and the lower ground bar is stamped and formed from sheet metal.

15. A contact assembly for an electrical connector, comprising:
a lower contact module having an insulator and a plurality of signal and ground contacts carried by the insulator;
a lower cap with an integrated lower ground bar in contact with the ground contacts of the lower contact module;
an upper contact module having an insulator and a plurality of signal and ground contacts carried by the insulator;
a pair of side plates attached to the insulator of the lower contact module, the lower cap, and the insulator of the upper contact module; and
an upper cap with an integrated upper ground bar in close proximity to the signal contacts of the upper contact module; wherein
each of the lower ground bar and the upper ground bar has a respective pair of side walls bearing against the pair of side plates.

16. The contact assembly as claimed in claim 15, wherein the upper ground bar comprises a flat copper assembled to the upper cap and a tape applied to the flat copper.

17. The contact assembly as claimed in claim 15, wherein the upper ground bar has no beams or like structure to contact the ground contacts.
